(19) United States
(12) Patent Application Publication
(10) Pub. No.: US 2012/0017405 A1
(43) Pub. Date: Jan. 26, 2012

(54) SNAP HOOK FOR ANIMAL LEASH

(75) Inventor: Satoshi TOZAWA, Osaka (JP)

(73) Assignee: RALLOC CO., LTD., Osaka (JP)

(21) Appl. No.: 13/180,772

(22) Filed: Jul. 12, 2011

(30) Foreign Application Priority Data
Jul. 20, 2010 (JP) 2010-163286

(51) Int. Cl. A01K 27/00; A44B 19/26

(52) U.S. Cl. 24/582.11

(57) ABSTRACT

A snap hook for an animal leash is configured to include a main body including a base, a tip portion positioned opposite to the base, a side face, and a forked portion extending from the base and positioned adjacent to the tip portion, the forked portion having a first prong and a second prong defining an opening therebetween for accepting an object, a slidable hook formed in the shape of the letter C and encased in the main body in a manner where the slidable hook can be rotatable back and forth, the slidable hook including a connection part closing the opening and being adapted to accept the object, the slidable hook including an operating part exposed from the side face for moving the slidable hook backward by an externally applied force, a ring rotatably connected to the base on an axis, and a spring for biasing the slidable hook toward the second prong to close the opening, the opening being opened when the biased connection part is moved from the second prong to the first prong, and the operating part being movable against the biasing force of the spring to rotate the slidable hook toward a position where the accepted object will be released therefrom.

The present disclosure relates to subject matter contained in priority Japanese Patent Application No. 2010-163286 filed on Jul. 20, 2010, the contents of which is herein expressly incorporated by reference in its entirety.

### BACKGROUND OF THE INVENTION

1. Field of the Invention

The present invention relates to a snap hook for an animal leash, and more particularly relates to a snap hook attached to a connection ring provided on a collar or a cloth of an animal to be led or held.

2. Description of the Related Art

Various types of snap hooks are known and used to hold an object such as animals or handbags. Such snap hooks include a hook portion for accepting the object. For use in holding an animal, an animal leash is connected to a snap hook, and a hook portion of the snap hook is attached to a connection ring such as D-ring provided on a collar or a cloth of an animal to be led or held.

A typical snap hook for this use is proposed in, for example, Japanese Patent Laid-Open Publication No. 2006-141205 (hereinafter Patent Document 1, see FIG. 9). The snap hook includes a sleeve portion, a hook portion extending from the sleeve portion, and a slidable bolt encased in the sleeve portion together with a spring. An end of the hook portion is opposed to an end of the slidable bolt so as to form an opening between the ends.

The sleeve portion is provided with a slit formed along the direction of the length of the sleeve portion. The slidable bolt has a knob, and is encased in the sleeve portion where the knob is exposed through the slit.

The opening, formed between the ends of the hook portion and the slidable bolt, allows for the ingress and egress of the object such as D-ring. The opening is closed by the slidable bolt, biased toward the end of the hook portion by use of the spring. The slidable bolt can be slid rearward to form the opening, by operating the knob of the slidable bolt.

Snap hooks of this nature may experience an unexpected detachment of the D-ring from the snap hook caused by unexpected action of an animal, such as when frightened or attracted by something while the animal is led or held, as taught by Patent Document 1. Such an unexpected detachment results from an entanglement between the snap hook and the D-ring, caused by unexpected action of an animal. Under such a condition, the D-ring may touch and push back the knob of the slidable bolt, resulting in opening of the slidable bolt. Patent Document 1 aims at preventing this kind of detachment of the D-ring from the snap hook. Patent Document 1 discloses providing a linkage ring between the snap hook and the D-ring to allow for free movement of the snap hook, in order to reduce the likelihood of the entanglement between the snap hook and the D-ring.

Another snap hook aimed at preventing this kind of detachment is proposed in Japanese Patent Laid-Open Publication No. 2009-72080 (hereinafter Patent Document 2). The configuration of this snap hook is similar to that disclosed in Patent Document 1, except in that the sleeve portion is provided with another slit for locking the knob of the slidable bolt (hereinafter “locking slit”.) The locking slit is parallel with the slit in the sleeve portion, and branches off from the slit at a position where the slidable bolt is pushed back halfway. To close the opening of the snap hook, the knob of the slidable bolt is led from the slit to the locking slit with the rotation of the slidable bolt. The knob is then moved along the locking slit to a closing position where the slidable bolt makes contact with the end of the hook portion. With this configuration, even if the knob is unexpectedly pushed back from the closing position, the knob will stop at the position where the slidable bolt is pushed back halfway. The likelihood of the unexpected detachment of the D-ring from the snap hook is thereby reduced.

However, the snap hook disclosed in Patent Document 1 has a configuration in which the linkage ring is simply provided between the snap hook and the D-ring. Depending on the amount of twist between the D-ring and the snap hook, the entanglement between the snap hook and the D-ring may occur, resulting in unexpected opening of the snap hook. Also, in the snap hook disclosed in Patent Document 2, there is a possibility that the knob, which is moved to the position where the slidable bolt is pushed back halfway, may be led from the locking slit to the slit, and may further be pushed back to a position where the slidable bolt is pushed back completely to form the opening.

### SUMMARY OF THE INVENTION

In light of the problems encountered by the conventional techniques, it is an object of the present invention to provide a snap hook for an animal leash which prevents a force for pushing back the knob, applied by the object such as D-ring, from being exerted on the exposed knob, by restricting a range of movement of the object.

In order to achieve the above object, a snap hook according to the present invention includes a main body including a base, a tip portion positioned opposite to the base, a side face, and a forked portion extending from the base and positioned adjacent to the tip portion, the forked portion having a first prong and a second prong defining an opening therebetween for accepting an object, a slidable hook formed in the shape of the letter C and encased in the main body in a manner where the slidable hook can be rotatable back and forth, the slidable hook including a connection part closing the opening and being adapted to accept the object, the slidable hook including an operating part exposed from the side face for moving the slidable hook backward by an externally applied force, a ring rotatably connected to the base on an axis, and a spring for biasing the slidable hook toward the second prong to close the opening, the opening being opened when the biased connection part is moved from the second prong to the first prong, and the operating part being movable against the biasing force of the spring to rotate the slidable hook toward a position where the accepted object will be released therefrom.

The above and other objects and features of the present invention will become apparent from the following description of preferred embodiments given in conjunction with the accompanying drawings.

### BRIEF DESCRIPTION OF THE DRAWINGS

FIG. 1 is a perspective view of a snap hook, connected to an object, for an animal leash according to an embodiment of the present invention;

FIG. 2 is a side view of the snap hook of FIG. 1, looked from an operating part thereof;

FIG. 3 is a front view of the snap hook looked in the direction of arrow III in FIG. 2;

FIG. 4 is a front view showing the internal structure of the snap hook of FIG. 3;

FIG. 5 is a front view of the snap hook similar to FIG. 4, but the snap hook is open; and

FIG. 6 is an exploded perspective view of the snap hook of FIG. 1.

### DETAILED DESCRIPTION OF THE PREFERRED EMBODIMENTS

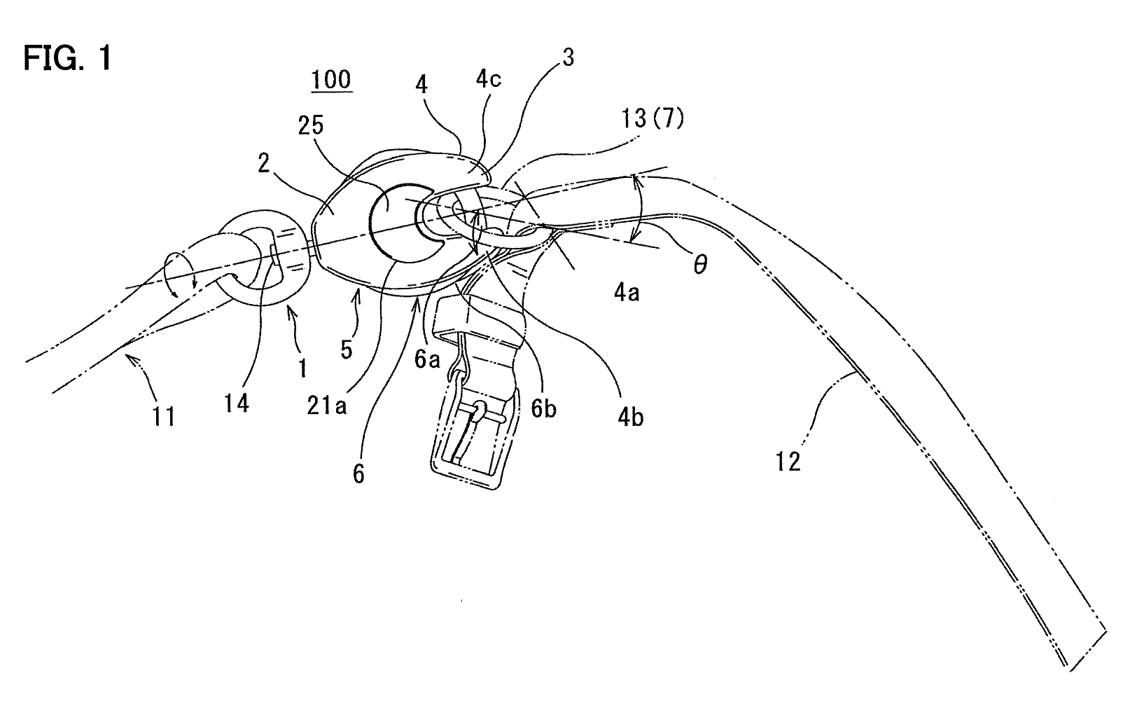

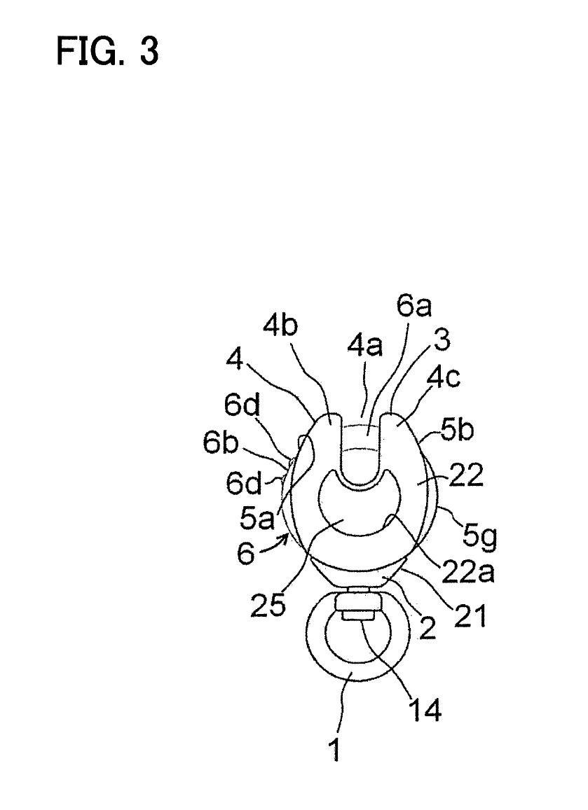

A snap hook for an animal leash according to an embodiment of the present invention will now be described with reference to FIG. 1 to FIG. 6. The snap hook is used to lead or hold small animals such as dogs or cats.

FIGS. 1 to 6 show the structure of a snap hook 100 for an animal leash according to the embodiment of the present invention. The snap hook 100 mainly includes a main body 5, a slidable hook 6, and a spring 8. The slidable hook 6 is formed in the shape of the letter C, and encased in the main body 5 such that the slidable hook 6 rotates back and forth. The slidable hook 6 includes a connection part 6a adapted to accept an object 7 to which the snap hook 100 is fastened.

FIG. 1 shows the snap hook 100, closed and connected to the object 7. As shown in FIG. 1, the main body 5 includes a base 2, a tip portion 3 positioned opposite to the base 2, and a forked portion 4. The forked portion 4 extends from the base 2, and is positioned adjacent to the tip portion 3. The base 2 is connected to a ring 1 via a stem 14 where the ring 1 is rotatable on the stem 14.

The forked portion 4 has two prongs, i.e., a first prong 4b and a second prong 4c, and an opening 4a is formed between the prongs 4b and 4c. The opening 4a allows for the ingress and egress of the object 7.

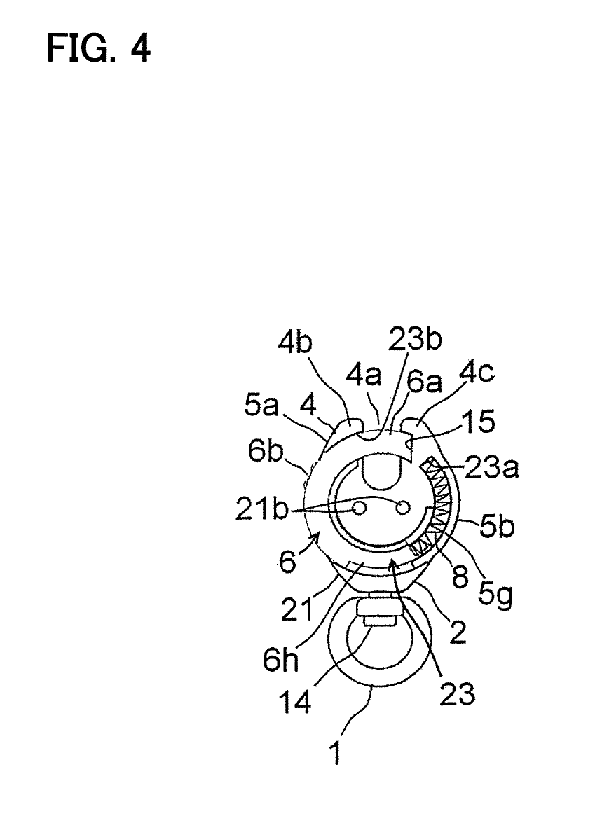

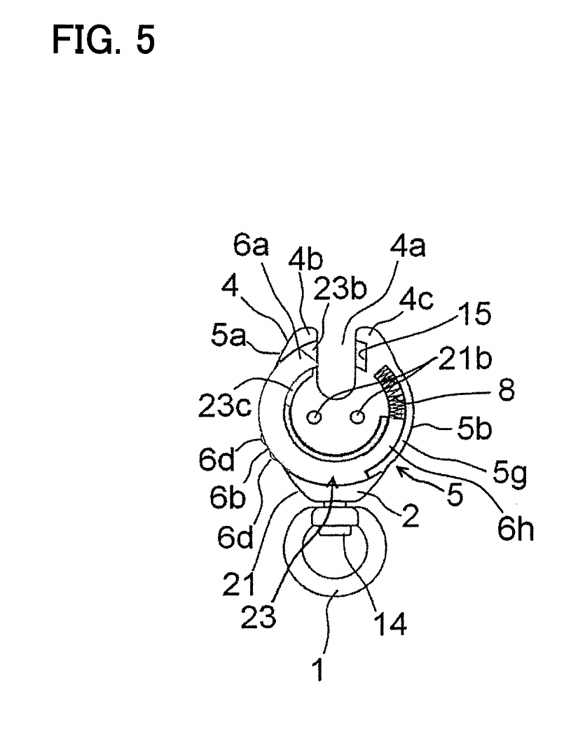

FIG. 4 and FIG. 5 respectively show the internal structure of the snap hook 100. As shown in FIG. 4 and FIG. 5, the spring 8 is encased in the main body 5. The spring 8 biases the slidable hook 6 toward the second prong 4c of the forked portion 4. The connection part 6a of the slidable hook 6 is thereby moved from the first prong 4b to the second prong 4c so as to close the opening 4a, as shown in FIG. 4. The snap hook 100 is thereby attached to the object 7.

In order to detach the snap hook 100 from the object 7, the opening 4a is formed by rotating the slidable hook 6 backward. The connection part 6a is thereby moved away from the forked portion 4, as shown in FIG. 5.

The backward rotation of the slidable hook 6 is effected by moving an operating part 6b of the slidable hook 6. The operating part 6b is exposed through a side wall of the main body 5 as shown in FIGS. 1 to 5. Moving the operating part 6b from a position shown in FIG. 4 to a position shown in FIG. 5 effects the backward rotation of the slidable hook 6 against the biasing force of the spring 8. That is, the slidable hook 6 is moved backward from a position of attachment shown in FIG. 4 to a position of detachment shown in FIG. 5.

The above-described snap hook 100 is used to lead or hold animals. In use, an animal leash 11 shown as an example by an imaginary line in FIG. 1, is connected to the ring 1 of the main body 5, and the slidable hook 6 is attached to the object 7. The object 7 is typically a D-ring 13 provided on a collar 12, shown as an example by an imaginary line in FIG. 1. The D-ring 13 may be provided on a collar, a harness, or a cloth of an animal to be led or held, such that the D-ring 13 can stand up.

The attachment of the slidable hook 6 to the object 7 is conducted as follows. Firstly, the main body 5 is picked up such that the thumb cushion touches the operating part 6b. The operating part 6b is moved by the thumb so as to move the slidable hook 6 backward from the position of attachment shown in FIG. 4 to the position of detachment shown in FIG. 5. The slidable hook 6, at first closes the opening 4a of the forked portion 4, is moved backward against the spring 8. The opening 4a of the forked portion 4 is thereby formed. Next, as shown in FIG. 1, the object 7 is inserted into the forked portion 4. The operating part 6b is then released, so that the slidable hook 6 is moved forward by biasing force of the spring 8, to the position of attachment shown in FIG. 1 and FIG. 4. The opening 4a is thus closed such that the slidable hook 6 engages with the object 7 inside the forked portion 4, as shown in FIG. 1. Thereby, the slidable hook 6 is firmly attached to the object 7.

With conventional snap hooks in which hook portions extend from main bodies, the attachment with the object is effected by closing the opening of the hook portion with the slidable bolt. When in use, such conventional snap hooks are prone to experience a twist between the hook portion of the snap hook and the D-ring (the object), and entanglement caused by the twist.

Specifically, the twist between the hook portion and the is D-ring may be caused by unexpected action of an animal, such as when frightened or attracted by something while the animal is led or held. The major portion of such a twist can usually be cancelled out by the rotation of the ring 1 on the stem 14. However, there is a likelihood that uncanceled twist causes entanglement of the main body with the D-ring.

This entanglement mainly occur where an axis of the D-ring inclines with respect to an axis of the hook portion of the main body at an angle (hereinafter referred to as “entanglement angle”.) This is because that the inclination of the axis of the D-ring with respect to the axis of the hook portion may impede the above-mentioned cancellation of the twist. In such cases, the D-ring twists around the main body with their axes intersecting at the entanglement angle.

Such entanglement of the main body with the D-ring can be exacerbated due to the entanglement angle in a case where the D-ring can freely move with respect to the hook portion, as with the conventional snap hook. Specifically, free movement of the main body and the D-ring within the available range of movement may exacerbate the entanglement of the main body and the D-ring.

There is a risk that a part of the D-ring (hereinafter referred to as “a preceding part”), positioned outside the hook portion, precedes and touches a knob of a slide bolt, resulting in pushing back and opening of the slide bolt. Although the probability of such opening of the slide bolt is low, there may be cases where such opening of the slide bolt occurs almost inevitably, depending on the direction or state of the entanglement.

In such cases, a part of the D-ring (hereinafter referred to as “a following part”), positioned inside the hook portion, follows the preceding part of the D-ring and moves along the inner curved portion of the hook portion so as to approach a thus formed opening of the hook portion. The following part of the D-ring can thus egress from the opening of the hook portion, following the pushing back and opening of the slide bolt by the preceding part of the D-ring. This results in an unexpected detachment of the D-ring from the hook portion.

In contrast to the above-mentioned conventional snap hook, in the snap hook 100 according to the present invention, movement of the object 7 toward the main body 5 is restricted within a range defined by the forked portion 4. As described above, the forked portion 4 is positioned adjacent to the center portion at the tip of the main body 5.

Under a condition where the snap hook 100 is attached to the object 7, excessive twist between the main body 5 and the object 7 may occur due to unexpected action of an animal, such as when frightened or attracted by something. Such excessive twist cannot be fully cancelled out by the rotation of the ring 1 on the stem 14 under a condition where tension is exerted between the animal leash 11 and the object 7 such as a collar or a cloth. Uncanceled twist causes entanglement of the main body 5 with the object 7. The object 7 applies external force on the main body 5.

The external force, applied by the object 7, is prevented from being exerted on the operating part 6b, because movement of the object 7 toward the main body 5 is restricted within a range defined by the forked portion 4. The slidable hook 6 is thereby prevented from being unexpectedly moved backward to the position of detachment shown in FIG. 5.

As described above, under a condition where the main body 5 is attached to the object 7 by use of the slidable hook 6 to lead or hold an animal, entanglement of the main body 5 with the object 7 may occur due to unexpected action of an animal, such as when frightened or attracted by something. Such entanglement occurs under a condition where tension is exerted between the animal leash 11 and the object 7 such as a collar or a cloth. The object 7 applies external force on the main body 5.

According to the snap hook 100, movement of the object 7 toward the main body 5 is restricted within a range defined by the forked portion 4 which is positioned adjacent to the center portion at the tip of the main body 5. The external force, applied by the object 7, is prevented from being exerted on the operating part 6b. The slidable hook 6 is thereby prevented from being unexpectedly moved backward to the position of detachment shown in FIG. 5. The snap hook 100 is less prone to experience unexpected detachment from the object 7. Secure connection with the object 7 is thereby achieved.

With reference to the drawings, the mechanism to prevent the unexpected detachment of the object 7 will be described in detail. As shown in FIG. 1, the ring 1 is rotatably connected to the base 2 of the main body 5 via the stem 14, where the stem 14 is located opposite to the center of the forked portion 4 and aligned with the axis of the main body 5. Under normal (expected) conditions where an animal is led or action of an animal which is held is restricted, tension is exerted between the D-ring 13 and the ring 1 by pulling the animal leash 11, on the inner curved portions thereof. The tension forcing the ring 1, the main body 5, and the D-ring 13 to approximately align with a same axis as if an axis of the ring 1, the axis of the main body 5, and the axis of the D-ring 13 form/share one axis, as shown in FIG. 1. Even if a twist occurs between the animal leash 11 and the D-ring 13 under a condition that the axes of the ring 1, the main body 5, and the D-ring 13 approximately align with a same axis, the twist can be cancelled out by mutual rotation between the main body 5 and the ring 1 on the stem 14.

However, due to unexpected action of an animal which is led or held, a condition may occur where the axis of the D-ring 13 inclines toward the opening 4a or either side of the connection part 6a within a certain range, as illustrated by the dashed line in FIG. 1. Then, the D-ring 13 will entangle with the connection part 6a at various positions where the axis of the D-ring 13 intersects the axis of the connection part 6a with an entanglement angle θ. Note that the entanglement angle θ is defined as an angle defined by the mutually-intersected axes of the connection part 6a and the D-ring 13.

The larger the entanglement angle θ is, the harder the cancellation of the twist performed by the rotation of the ring 1 is achieved. The cancellation of the twist is even harder to be achieved in a case where the twist occurs instantly.

According to the snap hook 100, the connection between the D-ring 13 and the connection part 6a is restricted within a range defined by the forked portion 4 (opening 4a). This prevents the D-ring 13 and the connection part 6a from getting entangled with a large entanglement angle θ. Thus, the D-ring 13 is kept from reaching the operating part 6b, as well as from applying force on the operating part 6b.

In a condition where the D-ring 13 entangles with the connection part 6a, a plane on which the D-ring 13 lies intersects a plane on which the forked portion 4 and the is connection part 6a lie. The D-ring 13 twists around the connection part 6a such that the D-ring 13 and the connection part 6a are pressed against each other at two points.

Between the two points, force is exerted on the D-ring 13 such that the two points locate apart from each other. That is, the D-ring 13, pressed against the connection part 6a at the two points, is forced to move toward the main body 5 along the curved portion of the D-ring 13. However, the movement of the D-ring 13 will soon be blocked by the forked portion 4. The D-ring 13 is thus prevented from reaching the operating part 6b, even if the D-ring 13 entangles with the connection part 6a.

Note that, in a case where tension is not exerted between the D-ring 13 and the ring 1, and where the D-ring 13 turns over and reaches the operating part 6b, the D-ring 13 is free from being applied force, in contrast to a case where tension is exerted between the D-ring 13 and the ring 1, and where the D-ring 13 entangles with the connection part 6a. Since the external force, applied by the D-ring 13, is not exerted on the operating part 6b, the slidable hook 6 is prevented from being unexpectedly moved backward to the position of detachment shown in FIG. 5. The snap hook 100 is free from unexpected detachment from the D-ring 13.

As shown in FIG. 1 through FIG. 6, the operating part 6b is composed of an outer side face 6c of the slidable hook 6. The outer side face 6c projects from a side face 5a of the main body 5. This eliminates a sideward projected operating part, similar to a conventional knob of a slidable bolt, from the slidable hook 6. Therefore, the slidable hook 6 is guided into the main body 5 through the outer side face 6c which is formed in a simple shape similar to a perfect circle.

In an example shown in the figures, the surface of the operating part 6b, composed of the outer side face 6c, has protrusions or recesses, in order to prevent slip of user's finger. Specifically, the operating part 6b has protrusions 6d formed in a direction perpendicular to a direction of operation of the operating part 6b. Recesses can be employed in place of the protrusions 6d. It is sufficient if the protrusions or recesses provide a snag in the direction of operation of the operating part 6b, that is, the direction in which the slidable hook 6 is moved backward, against the biasing force of the spring 8, from the position of attachment shown to the position of detachment. Note that recesses are preferable to the protrusions 6d in that the recesses are less prone to catch the object 7 such as the D-ring 13, even if the object 7 touches the recesses.

FIG. 4 shows the internal structure of the snap hook 100, in which the slidable hook 6 locates at the position of attachment. As shown in FIG. 4, the connection part 6a bridges the first and second prongs 4b and 4c of the forked portion 4, and the end of the connection part 6a is plugged in a recess 15 formed in the second prong 4c. The connection part 6a is thereby connected to the object 7.

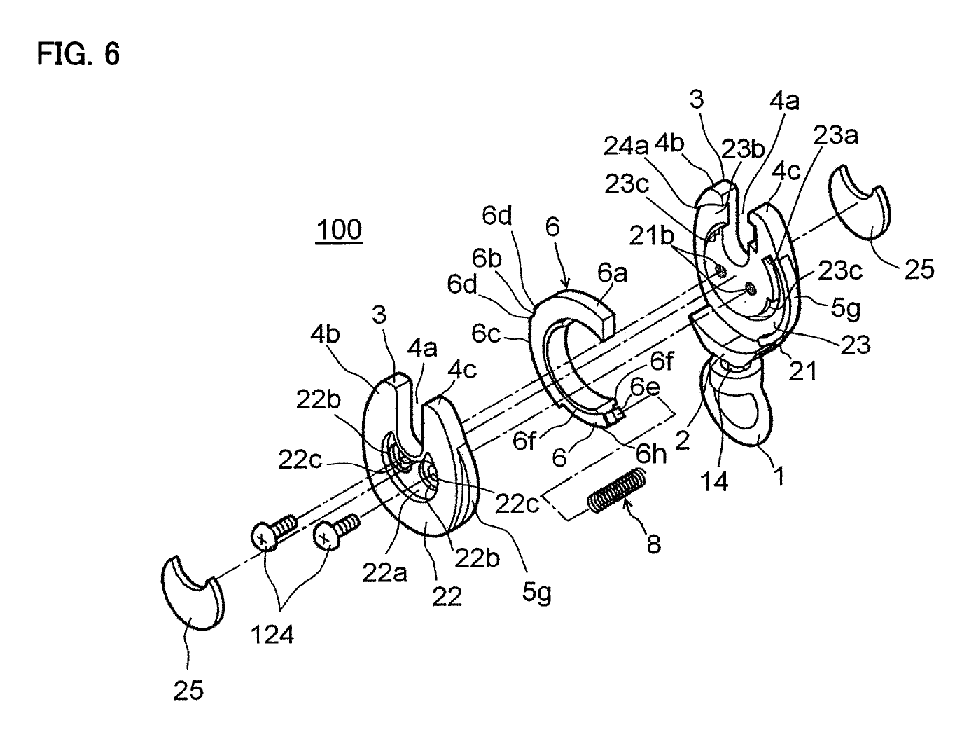

The slidable hook 6 is held by the main body 5 at two positions which sandwich the connection part 6a. The slidable hook 6 held as above has increased strength to bear a pulling force applied by the object 7. This configuration allows reducing the cross-sectional area of the slidable hook 6 to achieve sufficient strength thereof. Note that tension, exerted between the slidable hook 6 and the D-ring 13, is exerted almost only in a direction toward the opening 4a of the forked portion 4. In order to reduce the volume thereof, the slidable hook 6 has a rectangular cross section, as shown in FIG. 6. The cross section is a flat rectangle which has longer sides along the direction in which tension between the slidable hook 6 and the D-ring 13 is exerted.

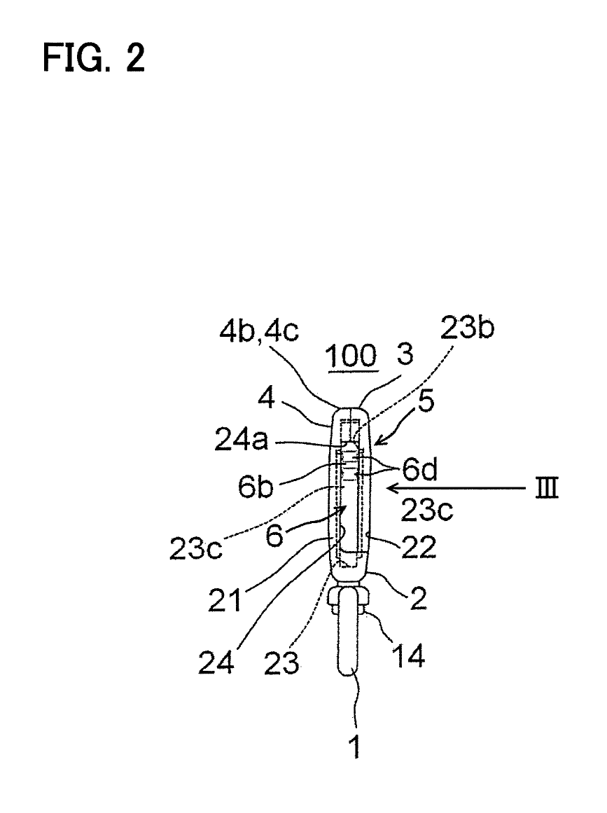

FIG. 2 and FIG. 6 show the structure of the main body 5 which encases the slidable hook 6 such that the slidable hook 6 rotates back and forth. Specifically, the main body 5 includes two half shell bodies 21 and 22 which form a path 23 therebetween. The slidable hook 6 is placed in the path 23, and rotates back and forth in the path 23. The main body 5 is fabricated by coupling the half shell bodies 21 and 22 with the slidable hook 6 and the spring 8 placed in the path 23, so that the slidable hook 6 and the spring 8 are sandwiched between the half shell bodies 21 and 22. This simplifies accommodating of the slidable hook 6 and the spring 8 in the main body 5. Thus fabricated main body 5 is less expensive.

In an example shown in the figures, the half shell bodies 21 and 22 are coupled by use of screws 124. This is preferable in that it is easy-to-maintenance, such as an exchange of the spring 8. Alternatively, the half shell bodies 21 and 22 can be coupled by use of rivets, or an adhesive. The half shell bodies 21 and 22 can also be coupled by swaging a connection bar which is integrally provided with one of the bodies 21 and 22, and penetrate the other of the bodies 21 and 22.

As shown in FIG. 6, the half shell body 22 has a recess 22a. Countersinks 22b and clearance holes 22c are formed in the recess 22a. Similarly, the half shell body 21 has a recess 21a (see FIG. 1), and holes 21b are formed in the recess 21a. The screws 124 are threaded through the clearance holes 22c such that the heads thereof are accommodated in the countersinks 22b. The screws 124 are then secured to the half shell body 21 by screwing the screws 124 into the holes 21b.

Plates 25, shown in FIG. 1 through FIG. 6, are fitted over the recesses 21a and 22a, in order to cover the ends of the screws 124. The plates 25 are attached to the half shell bodies 21 and 22 by fitting or adhering, such that the plates 25 are detachable when necessary to perform the above-mentioned maintenance.

FIG. 6 shows the configuration of the slidable hook 6. The slidable hook 6 could be classified into two portions having different widths. A first portion has a first width. The first portion refers to a portion extending from the connection part 6a to a position beyond a range which is exposed from the side face 5a of the main body 5 in a condition that the slidable hook 6 locates at the position of attachment as shown in FIG. 4. The slidable hook 6 (the operating part 6b) is exposed from a window 24 (see FIG. 2) formed in the side face 5a.

A second portion 6h has a second width smaller than the first width. At the end of the second portion 6h, provided is a protrusion 6e having a width smaller than the second width. The protrusion 6e is provided for receiving the spring 8. The spring 8 is placed between the protrusion 6e and an end 23a of the path 23.

The path 23 can be formed between the half shell bodies 21 and 22 in a variety of ways. In an example shown in the figures, a part of the path 23 is formed by coupling the half shell bodies 21 and 22, in which halves of the part of the path 23 are cut. Specifically, the above-mentioned part refers to a portion extending from an upper edge 24a of the window 24 to an opening 23b formed in the first prong 4b, as shown in FIG. 2 and FIG. 6. The recess 15 in the second prong 4c is formed similarly.

The remainder of the path 23 is cut only in the half shell body 21, which is covered by the half shell body 22.

A radius of curvature of the operating part 6b is approximately half of that of the side face 5a of the main body 5. About one fourths of the operating part 6b similarly formed a perfect circle is exposed from the side face 5a through the window 24 formed therein. Thus, an area of the path 23, surrounding the window 24, is weak in retaining the slidable hook 6, although the slidable hook 6 is not subjected to a force exerted toward the window 24.

In order to prevent the slidable hook 6 from moving toward the window 24, and to retain the slidable hook 6 within the path 23, the slidable hook 6 is integrally provided with a pair of ridges 6f and 6f (see FIG. 6). Specifically, the ridges 6f and 6f are provided along both sides of the inner radius of the slidable hook 6. Further, the path 23 is provided with a pair of retaining grooves 23c for receiving and engaging the pair of ridges 6f and 6f. The retaining grooves 23c have a depth larger than that of the path 23. The retaining grooves 23c are provided along both sides of the inner radius of the path 23, such that the ridges 6f rotate back and forth in the retaining grooves 23c.

A side face 5b of the main body 5 is formed in a shape whose outline is symmetric to a portion of the slidable hook 6. From that portion, an outer arc portion of the slidable hook 6 protrudes. A side wall 5g corresponding to the protruding portion is used as an outer wall of the side face 5b of the path 23. The path 23 accommodates the second portion 6h of the slidable hook 6 in a manner where the second portion 6h can be rotatable back and forth. The path 23 further accommodates the spring 8 therein. Thus, the main body 5 can be formed in a symmetric shape, and serves the easy-to-handle operationability to the user due to a nice looking and oval shape thereof.

As previously described, the main body 5 is formed by the two half shell bodies 21 and 22. The half shell body 21 has the base 2 of the main body 5 connected to the ring 1. In the half shell body 21, the portion from the base 2 to the forked portion 4 mates with the half shell body 22. Thus, the ring 1 and the base 2 can be connected by the main body 5 which is in a simple construction but strong enough to stand the force applied to the connection portion thereof.

As described above, the snap hook according to the present invention prevents unexpected detachment of the object from the snap hook caused by unexpected pushing back of the slidable hook due to entanglement between the object and the snap hook caused by twist between the object and the snap hook. This is achieved by providing the main body of the snap hook with the forked portion positioned adjacent to the tip portion of the main body, and by providing the slidable hook which closes the opening of the forked portion and connected to the is object, in place of the conventional hook portion and slide bar.

While preferred embodiments of the invention have been described using specific terms, such description is for illustrative purposes only, and it is to be understood that changes and variations may be made without departing from the spirit or scope of the following claims.

What is claimed is:

1. A snap hook for an animal leash, comprising:
a main body including
a base,
a tip portion positioned opposite to the base,
a side face, and
a forked portion extending from the base and positioned adjacent to the tip portion, the forked portion having a first prong and a second prong, the first and second prongs defining an opening therebetween for accepting an object;
a slidable hook formed in a shape of letter C and encased in the main body in a manner where the slidable hook can be rotatable back and forth, the slidable hook including a connection part for closing the opening and for accepting the object, the slidable hook including an operating part exposed from the side face for moving the slidable hook backward by an externally applied force;
a ring rotatably connected to the base on an axis; and
a spring for biasing the slidable hook toward the second prong to close the opening, the opening being opened when the biased connection part is moved from the second prong to the first prong, and the operating part being movable against the biasing force of the spring to rotate the slidable hook toward a position where the accepted object will be released therefrom.

2. The snap hook for an animal leash according to claim 1, wherein the operating part is composed of an outer side face of the slidable hook, the outer side face projecting from the side face of the main body.

3. The snap hook for an animal leash according to claim 1, wherein he second prong is proved a recess in which the connection part is plugged to close the opening.

4. The snap hook for an animal leash according to claim 1, wherein the main body is fabricated by coupling two half shell bodies and is provided with a path extending therein for accommodating the slidable hook and the spring, and the slidable hook rotates back and forth in the path.
